(19) United States
(12) Patent Application Publication
(10) Pub. No.: US 2007/0298346 A1
(43) Pub. Date: Dec. 27, 2007

(54) Toner particles of controlled morphology

(75) Inventors: Matthew C. Ezenyilimba, Albequerque, NM (US); John C. Wilson, Rochester, NY (US); Gretchen S. McGrath, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/472,779

(22) Filed: Jun. 22, 2006

(51) Int. Cl. G03G 9/08

(52) U.S. Cl. 430/137.1

(57) ABSTRACT

A method for the preparation of electrostatographic toner comprising the steps of: a) dissolving a polymer material and a quaternary ammonium tetraphenylborate salt in an organic solvent to form an organic phase; b) dispersing the organic phase in an aqueous phase comprising a particulate stabilizer to form a dispersion and homogenizing the resultant dispersion; c) evaporating the organic solvent and recovering a resultant product; and d) washing and drying the resultant product.

### FIELD OF THE INVENTION

This invention relates to a method for the preparation of polymeric powders suitable for use as electrostatographic toner, and more particularly, to a method for the preparation of toner particles of controlled shape in which certain quaternary ammonium tetraphenylborate salts are employed for controlling morphology of the toner particles.

### BACKGROUND OF THE INVENTION

Electrostatic toner polymer particles can be prepared by a process frequently referred to as “limited coalescence”. In this process, polymer particles having a narrow size distribution are obtained by forming a solution of a polymer in a solvent that is immiscible with water, dispersing the solution so formed in an aqueous medium containing a solid colloidal stabilizer and removing the solvent by evaporation. The resultant particles are then isolated, washed and dried.

In the practice of this technique, toner particles are prepared from any type of polymer that is soluble in a solvent that is immiscible with water. Thus, the size and size distribution of the resulting particles can be predetermined and controlled by the relative quantities of the particular polymer employed, the solvent, the quantity and size of the water insoluble solid particulate suspension stabilizer, typically silica or latex, and the size to which the solvent-polymer droplets are reduced by agitation.

Limited coalescence techniques of this type have been described in numerous patents pertaining to the preparation of electrostatic toner particles because such techniques typically result in the formation of toner particles having a substantially uniform size distribution. Representative limited coalescence processes employed in toner preparation are described in U.S. Pat. No. 4,833,060 and 4,965,131 to Nair et al.

U.S. Pat. No. 5,283,151 is representative of earlier work in this field and describes the use of carnauba wax to achieve similar toner morphology. The method comprises the steps of dissolving carnauba wax in ethyl acetate heated to a temperature of at least 75° C. and cooling the solution, so resulting in the precipitation of the wax in the form of very fine needles a few microns in length; recovering the wax needles and mixing them with a polymer material, a solvent and optionally a pigment and a charge control agent to form an organic phase; dispersing the organic phase in an aqueous phase comprising a particulate stabilizer and homogenizing the mixture; evaporating the solvent and washing and drying the resultant product.

Unfortunately, this technique requires the use of elevated temperature to dissolve the wax in the solvent and cooling the solution to precipitate the wax. The wax does not stay in solution of ethyl acetate at ambient temperature and as a result it is very difficult to scale up using this methodology.

The shapes of the toner particles have a bearing on the electrostatic toner transfer and cleaning properties. Thus, for example, the transfer and cleaning efficiency of toner particles have been found to improve as the sphericity of the particles are reduced. Thus far, workers in the art have long sought to modify the shape of the evaporative limited coalescence type toner particles by means other than the choice of pigment, binder, or charge agent. The shape of the toner particles are modified to enhance the cleaning and transfer properties of the toner.

### SUMMARY OF THE INVENTION

A method for the preparation of electrostatographic toner comprising the steps of: a) dissolving a polymer material and a quaternary ammonium tetraphenylborate salt in an organic solvent to form an organic phase; b) dispersing the organic phase in an aqueous phase comprising a particulate stabilizer to form a dispersion and homogenizing the resultant dispersion; c) evaporating the organic solvent and recovering a resultant product; and d) washing and drying the resultant product.

### DETAILED DESCRIPTION OF THE INVENTION

In accordance with the present invention, a pigment dispersion is prepared by conventional techniques as, for example, by media milling, melt dispersion and the like. The pigment dispersion, polymer material, a solvent and optionally a charge control agent are combined to form an organic phase in which the pigment concentration ranges from about 4% to 20%, by weight, based upon the total weight of solids. The charge control agent is employed in an amount ranging from 0 to 10 parts per hundred by weight, based on the total weight of solids, with a preferred range from 0.2 to 3.0 parts per hundred. This mixture is permitted to stir overnight and then dispersed in an aqueous phase comprising a particulate stabilizer and optionally a promoter.

The solvents chosen for use in the organic phase steps may be selected from among any of the well-known solvents capable of dissolving polymers. Typical of the solvents chosen for this purpose are chloroform, dichloromethane, ethyl acetate, vinyl chloride, methyl ethyl ketone, and the like.

The particulate stabilizer selected for use herein may be selected from among highly cross-linked polymeric latex materials of the type described in U.S. Pat. No. 4,965,131 to Nair et al., or silicon dioxide. Silicon dioxide is preferred. It is generally used in an amount ranging from 1 to 15 parts by weight based on 100 parts by weight of the total solids of the toner employed. The size and concentration of these stabilizers control and predetermine the size of the final toner particles. In other words, the smaller the size and/or the higher the concentration of such particles, the smaller the size of the final toner particles.

Any suitable promoter that is water soluble and affects the hydrophilic/hydrophobic balance of the solid dispersing agent in the aqueous solution may be employed in order to drive the solid dispersing agent, that is, the particulate stabilizer, to the polymer/solvent droplet-water interface. Typical of such promoters are sulfonated polystyrenes, alginates, carboxymethylcellulose, tetramethyl ammonium hydroxide or chloride, diethylaminoethyl methacrylate, water soluble complex resinous amine condensation products of ethylene oxide, urea and formaldehyde and polyethyleneimine. Also, effective for this purpose are gelatin, casein, albumin, gluten and the like or non-ionic materials such as methoxycellulose. The promoter is generally used in an amount from about 0.2 to about 0.6 parts per 100 parts, by weight, of aqueous solution.

Various additives generally present in electrostatograhic toner may be added to the polymer prior to dissolution in the solvent or in the dissolution step itself, such as charge control agents, waxes and lubricants. Suitable charge control agents are disclosed, for example, in U.S. Pat. Nos. 3,893,935 and 4,323,634 to Jadwin et al. and U.S. Pat. No. 4,079,014 to Burness et al., and British Patent No. 1,420,839 to Eastman Kodak. Charge control agents are generally employed in small quantities such as from about 0.01 to 10 parts per hundred by weight based upon the weight of the total solids content (weight of the toner) and preferably from about 0.2 to about 3.0 parts per hundred.

The resultant mixture is then subjected to mixing and homogenization. In this process, the particulate stabilizer forms an interface between the organic globules in the organic phase. Due to the high surface area associated with small particles, the coverage by the particulate stabilizer is not complete. Coalescence continues until the surface is completely covered by particulate stabilizer. Thereafter, no further growth of the particles occurs. Accordingly, the amount of the particulate stabilizer is inversely proportional to the size of the toner obtained. The relationship between the aqueous phase and the organic phase, by volume may range from 1:1 to approximately 9:1. This indicates that the organic phase is typically present in an amount from about 10% to 50% of the total homogenized volume.

Following the homogenization treatment, the solvent present is evaporated and the resultant product washed and dried.

As indicated, the present invention is applicable to the preparation of polymeric toner particles from any type of polymer that is capable of being dissolved in a solvent that is immiscible with water and includes compositions such as, for example, olefin homopolymers and copolymers, such as, polyethylene, polypropylene, polyisobutylene and polyisopentylene; polytrifluoroolefins; polytetrafluoroethylene and polytrifluorochloroethylene; polyamides, such as poly(hexamethylene adipamide), poly(hexamethylene sebacamide), and polycaprolactam; acrylic resins, such as poly(methyl methacrylate), poly(methyl acrylate), poly(ethyl methacrylate) and poly(styrene-methyl methacrylate); ethylene-methyl acrylate copolymers, ethylene-ethyl acrylate copolymers, ethylene-ethyl methacrylate copolymers, polystyrene and copolymers of styrene with unsaturated monomers, cellulose derivatives, polyesters, polyvinyl resins and ethylene-allyl alcohol copolymers and the like.

Pigments suitable for use in the practice of the present invention should be capable of being dispersed in the polymer, insoluble in water and yield strong permanent color. Typical of such pigments are the organic pigments such as phthalocyanines, lithols and the like and inorganic pigments such as TiO₂, carbon black and the like. Typical of the phthalocyanine pigments are copper phthalocyanine, a mono-chlor copper phthalocyanine, and hexadecachlor copper phthalocyanine. Other organic pigments suitable for use herein include anthraquinone vat pigments such as vat yellow 6GLCL1127, quinone yellow 18-1, indanthrone CL1106, pyranthrone CL1096, brominated pyranthrones such as dibromopyranthrone, vat brilliant orange RK, anthramide brown CL1151, dibenzanthrone green CL1101, flavanthrone yellow CL1118, azo pigments such as toluidine red C169 and hansa yellow; and metallized pigments such as azo yellow and permanent red. The carbon black may be any of the known types such as channel black, furnace black, acetylene black, thermal black, lamp black and aniline black. The pigments are employed in an amount sufficient to give a content thereof in the toner from about 1% to 40%, by weight, based upon the weight of the toner, and preferably within the range of 4% to 20%, by weight.

The quaternary ammonium tetraphenylborate salts of the invention can be represented by the following general structural formulae:

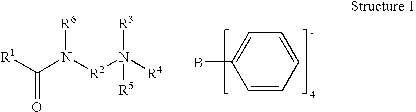

Where R¹ is substituted or unsubstituted alkyl or aryl; R² is alkylene or arylene; R³, R⁴ and R⁵ are substituted or unsubstituted alkyl and R³ and R⁴ taken together may form a cyclic ring system. R⁶ is hydrogen or alkyl.

Examples of R¹ include methyl, ethyl, n-propyl, n-butyl, n-hexyl, n-undecyl, heptadecyl, phenyl, 4-methylphenyl, 4-t-butylphenyl, and the like.

Examples of R² include ethylene, 1,3-propylene, 1,4-butylene, hexamethylene, p-phenylene, and the like.

Examples of R³, R⁴ and R⁵ include methyl, ethyl, propyl, octadecyl, benzyl, and the like; R³ and R⁴ taken together may be 1,4-butylene, 1,5-pentylene, and the like;

Examples of R⁶ include hydrogen, methyl, ethyl, n-propyl, n-butyl, octadecyl, benzyl and the like.

Preferably, R¹ is undecyl, R² is 1,3-propylene, R³ is methyl, R⁴ is methyl, R⁵ is benzyl and R⁶ is hydrogen.

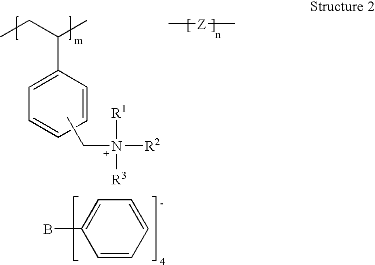

Where R¹, R² and R³ are the same or different and are alkyl or substituted alkyl and taken together may form a cyclic ring structure. Examples of R¹, R² and R³ include methyl, ethyl, n-propyl, isopropyl, n-butyl, iso-butyl, t-butyl, n-octyl, n-octadecyl, benzyl, and the like. The vinyl benzyl moiety may be any of the ortho, meta or para isomers alone or in combination. The weighted percents in the feed are represented by m and n which total 100 and m may have a value from 0.01 to 100.00 weight percent. Z is any copolymerizable monomer residue and may include more than one comonomer. Comonomers include isobutyl methacrylate, isobutyl acrylate, methyl methacrylate, methyl acrylate, styrene, 4-t-butylstyrene, methyl vinyl ether, acrylamide, methacrylamide, and the like.

Preferably, R¹ is octadecyl, R² is methyl, R³ is methyl, Z is isobutyl methacrylate, m is 10 and n is 90.

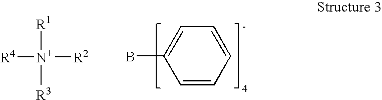

Where R¹, R², R³ and R⁴ are the same or different and are alkyl or substituted alkyl, R¹ and R² taken together may form a cyclic ring system.

Examples of R¹, R², R³ and R⁴ include methyl, ethyl, propyl, isopropyl, butyl, t-butyl, pentyl, hexyl, 2-ethylhexyl, heptyl, octyl, decyl, octadecyl, benzyl, 2-napthylmethyl, and the like. Examples of R¹ and R² taken together include 1,4-butylene, 1,5-pentylene, and the like. Preferably, R¹ and R² are methyl, R³ is octadecyl and R⁴ is benzyl.

The following examples illustrate the practice of this invention. They are not intended to be exhaustive of all possible variations of the invention. Parts and percentages are by weight unless otherwise indicated.

### EXAMPLES

### Preparation of N,N-Dimethyl-N-octadecyl-4-vinylbenzylammonium chloride

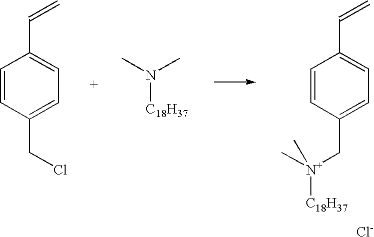

A solution of 30.0 g (197 mmol) of 4-vinylbenzyl chloride and 58.4 g (197 mmol) of N,N-dimethyloctadecylamine together with a small amount of t-butylpyrocatchol inhibitor in 200 ml of acetone was stirred overnight. The precipitate, which formed, was collected after adding 100 ml of acetone and stirring to break up cake, and washed with acetone and dried. The yield of product was 71.25 g (80.34% of theory); Tm=164.5° C. (by DSC).

Anal Calcd for C₂₉H₅₂NCl: C, 77.38; H, 11.63; N, 3.11; Cl, 7.88; Found: C, 77.25; H, 11.71; N, 3.22; Cl, 6.94.

### Preparation of N,N-Dimethyl-N-octadecyl-4-vinylbenzylammonium Tetraphenylborate

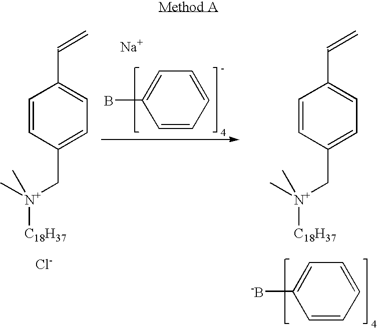

A solution of 22.51 g (50 mmol) of N,N-dimethyl-N-octadecyl-4-vinylbenzylammonium chloride in 500 ml of water was poured into a solution of 17.11 g (50 mmol) of sodium tetraphenylborate in 250 ml of water. Decanted milky aqueous phase from the white precipitate and rinsed the precipitate with water. The solid was recrystallized from acetonitrile, collected and dried. The yield of product was 8.37 g (22.8% of theory); mp=81-3° C.

Anal Calcd. For C₅₃H₇₂NB: C, 86.7; H, 9.9; N, 1.9; B, 1.5; Found C, 87.07; H, 9.96: N, 1.91; B, 1.6.

### Method B

A solution of 30.4 g (89 mmol) of sodium tetraphenylborate in 250 ml of water was added to a solution of 40.0 g (89 mmol) of N,N-dimethyl-N-octadecyl-4-vinylbenzylammonium chloride in 250 ml of methanol with vigorous stirring. The solid was collected, washed with ethanol and recrystallized from 700 ml of 2:3 acetonitrile:ethanol. The solid was collected, washed with ethanol and dried to give 49.75 g (76.3% of theory) of product; mp=82.5-4° C.

Anal Calcd. For C₅₃H₇₂NB: C, 86.7; H, 9.9; N, 1.9; B, 1.5; Found: C, 86.59; H, 9.81; N, 1.96; B, ND.

### Preparation Copoly[N,N-Dimethyl-N-octadecvl-4 vinylbenzylammonium Tetraphenylborate: Isobutyl Methacrvlate10:90]

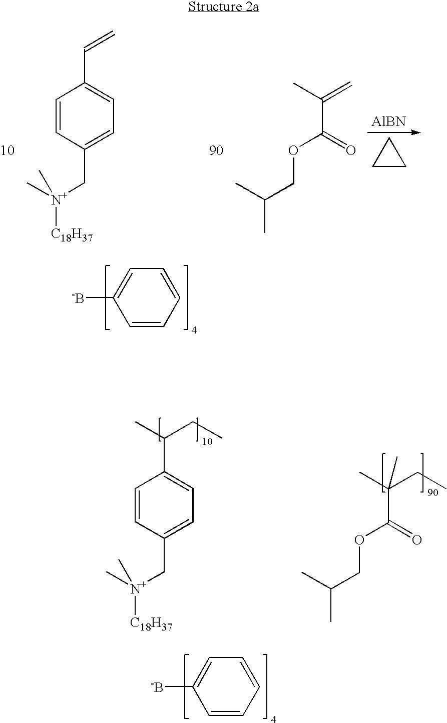

A solution of 5.00 g of N,N,-dimethyl-N-octadecyl-4-vinylbenzylammonium tetraphenylborate and 45.00 g of isobutyl methacrylate in 50.00 g of p-dioxane was purged with nitrogen in a 70° C. bath. To this solution was added 0.25 g of AIBN and the solution was heated at 70° C. overnight. The highly viscous solution was diluted with 50 ml of p-dioxane and poured into methanol with stirring to precipitate the polymer. The polymer was isolated, rinsed again with methanol and redissolved in methylene chloride. The polymer was reprecipitated in methanol, collected and dried. The yield of polymer was 28.2 g and had an inherent viscosity in methylene chloride (0.25 g/dl) of 0.66.

Table 3 lists examples of other quaternary ammonium tetraphenylborate copolymers.

### Preparation of N-(3-Dimethylaminopropyl)Lauramide

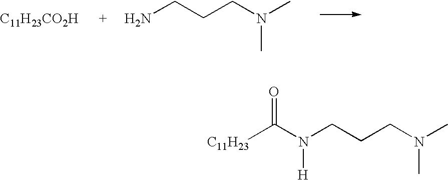

A mixture of 1000.0 g (5.0 mol) of lauric acid and 510.2 g (5.0 mol) of 3-dimethylaminopropylamine was placed in a 3-neck 2 liter flask equipped with blade stirrer and Vigreax column with takeoff head. The mixture was heated with stirring in an oil bath over a 2.42 hour period while gradually increasing the bath temperature to 219° C. while collecting the water condensate. The mixture was placed on oil pump vacuum for 15 min to remove any remaining water and cooled. The yield of product was 1346.4 g (94.7% of theory).

### Preparation of N,N-Dimethyl-N-(3-lauramidopropyl)benzylammonium Chloride

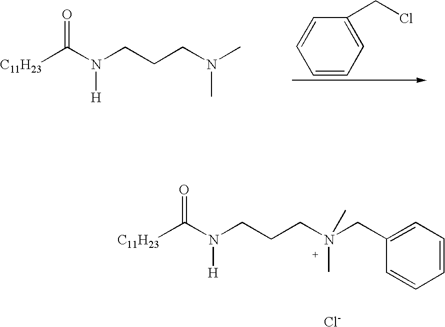

A solution of 116.38 g (0.409 mot) of N-(3-dimethylaminopropyl) lauramide and 51.79 g (0.409 mol) of benzyl chloride in 500 ml of acetone was stirred at room temperature for 48 hrs. The solution was concentrated to a viscous oil. The yield of product was 167.2 g (99.4% of theory).

### Preparation of N,N-Dimethyl-N-(3-lauramidopropyl)benzylammonium Tetraphenylborate

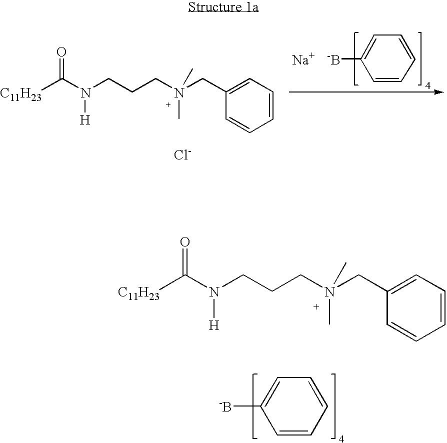

A solution of 1944.36 g (4.73 mol) of N,N-dimethyl-N-(3 lauramidopropyl)benzylammonium chloride in 8 liters of water was added to a solution of 1618.84 g (4.73 mol) of sodium tetraphenylborate in 10 liters of water. A gummy solid formed which was taken up in methylene chloride, dried over magnesium sulfate and concentrated. Ether was added to the residual oil resulting in the formation of solid. The solid was collected and dried to give 2273.5 g (69.2% of theory) of product; mp=112-18° C.

Anal. Calcd. for C₄₈H₆₃N₂OB: C, 83.0; H, 9.1; N, 4.0; Found: C, 82.60; H, 9.20; N, 3.95;

### Preparation of N,N-Dimethyl-N-octadecylbenzylammonium tetraphenylborate

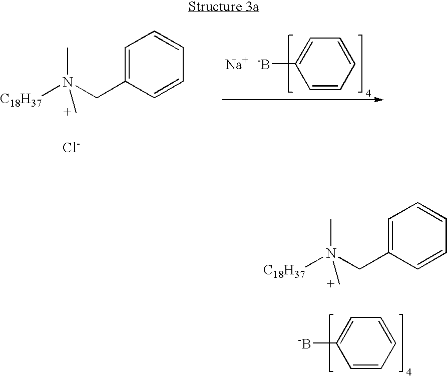

A solution of 42.42 g (0.10 mol) of N,N-dimethyl-N-octadecylbenzylammonium chloride in 500 ml of water and 34.22 g (0.10 mol) of sodium tetraphenylborate in 150 ml of water were combined. The white precipitate was collected and washed with ethanol. The crude material was recrystallized from 1500 ml of ethanol+150 ml of acetonitrile, collected and dried. The yield of product was 58.0 g (81.9% of theory); mp=131.5-3° C.

Anal. Calcd. for C₅₁H₇₀NB: C, 86.5; H, 10.0; N, 2.0; B, 1.53; Found: C, 86.05; H, 10.14; N, 1.93; B, 1.69;

### Preparation of N-(3-Lauramidopropyl)trimethylammonium Iodide

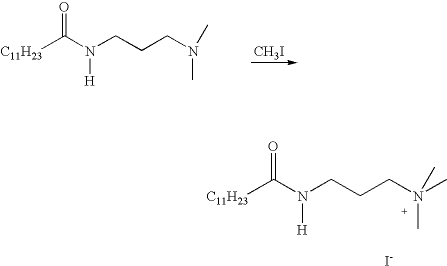

A solution of 30.0 g (0.105 mol) of N-(3-dimethylaminopropyl) lauramide, 15.0 g (0.105 mol) of methyl iodide and 120 ml of acetone was prepared. The solution was cooled in a cold water bath to dissipate the heat of reaction. Within 10 minutes, a white solid formed. The reaction mixture was allowed to stand for 5 hrs after removing the cooling bath. The solid was collected, washed with acetone and dried The yield of products was 38.8 g (86.7% of theory).

### Preparation of N-(3-Lauramidopropyl)trimethylammonium Tetraphenylborate

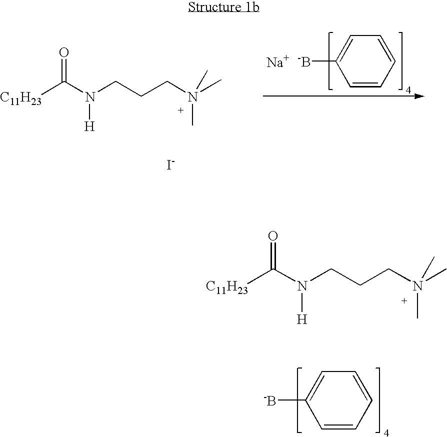

A solution 38.8 g (0.091 mol) of N-(3-lauramidopropyl)trimethylammonium iodide in 150 ml of methanol and 31.15 g (0.091 mol) of sodium tetraphenylborate in 150 ml of water was combined with vigorous stirring. The white precipitate was collected, washed with water and recrystallized from a mixture of 600 ml of ethanol and 30 ml of acetonitrile. The solid was collected, washed with ethanol and dried. The yield of product was 46.2 g (82.1% of theory); mp=173-5° C.

Anal. Calcd. for C₄₂H₅₉N₂OB: C, 81.5; H, 9.6; N, 4.5; Found: C, 81.35; H, 9.73; N, 4.52.

Tables 4 and 5 list other quaternary ammonium tetraphenylborate examples.

### Comparative Example I

A media milled dispersion of Hostaperm pink (manufactured by Hoechst Celanese) was prepared from a mixture of 91.0 g of the Hostaperm pink pigment, 9.0 g of commercially available styrene butyl acrylate polymer (piccotoner 1221) in 670.0 g of ethyl acetate (13.0% solids of mixture). To 37.0 g of the above media milled dispersion were then added 20.2 g of Kao C binder and 26.2 g of ethyl acetate. This mixture was comprised of 17.5% pigment and 82.5% binder and comprised the organic phase in the evaporative limited coalescence process. The organic phase was then mixed with an aqueous phase comprising 85 ml of pH4 buffer containing 14.5 g of Nalco™ 1060 and 3.2 ml of 10% poly (adipic acid-comethylaminoethanol). This mixture was then subjected to very high shear using a Polytron sold by Brinkman followed by a Microfluidizer. Upon exiting, the solvent was removed from the particles so formed by stirring overnight at room temperature in an open container. These particles were washed with 0.1N potassium hydroxide solution to remove the silica followed by water and dried. The toner particles were of the order of 4.2μ volume average and entirely spherical with BET number of 0.90 m²/g.

### Comparative Example II

The procedure of Comparative Example I was repeated with the exception that 10.0% Bridged Aluminum Phthalocyanine/Copper Phthalocyanine pigments manufactured by Eastman Kodak and BASF respectively replaced the magenta pigment. The resultant particles were spherical and particle size was 4.0μ with BET number of 0.60 m²/g.

### Comparative Example III

The procedure of Comparative Example I was repeated with the exception that the magenta pigment was replaced by 10.0% Pigment Yellow 180 manufactured by BASF. The resultant particles were spherical and particle size was 3.6μ with BET number of 0.95 m²/g.

### Comparative IV

The procedure of Comparative Example I was repeated with the exception that the magenta pigment was replaced by 8.0% carbon black (Black Pearls 280) manufactured by CABOT. The resultant particles were completely spherical and particle size was 4.9μ with BET number of 0.50 m²/g.

### Example 1

To 37.0 g of the Hostaperm Pink media milled dispersion were then added 20.2 g of Kao C binder, 0.25 g of Structure 1a (1.0%), 0.75 g of Structure 2a (3.0%) and 26.2 g of ethyl acetate. This mixture was comprised of 17.5% pigment and 82.5% binder and comprised the organic phase in the evaporative limited coalescence process. The organic phase was then mixed with an aqueous phase comprising 85 ml of pH4 buffer containing 14.5 g of Nalco™ 1060 and 3.2 ml of 10% poly (adipic acid-comethylaminoethanol). This mixture was then subjected to very high shear using a Polytron sold by Brinkman followed by a Microfluidizer. Upon exiting, the solvent was removed from the particles so formed by stirring overnight at room temperature in an open container. These particles were washed with 0.1N potassium hydroxide solution to remove the silica followed by water and dried. The toner particles were of the order of 3.5μ volume average and entirely non-spherical with BET number of 2.23 m²/g.

### Example 2

The procedure of Example 1 was repeated with the exception that magenta pigment was replaced with 10.0% BrAIPc/CuPc cyan pigment. The resultant particles were completely non-spherical and particle size was 3.8μ with BET number of 1.99 m²/g.

### Example 3

The procedure of Example I was repeated with the exception that magenta pigment was replaced with 10.0% Pigment Yellow 180. The resultant particles were completely non-spherical and particle size was 4.3μ with BET number of 1.93 m²/g.

### Example 4

The procedure of Example I was repeated with the exception that magenta pigment was replaced with 8.0% carbon black (Black Pearls 280). The resultant particles were completely non-spherical and particle size was 3 8μ with BET number of 1.26 m²/g.

### Example 5

To 21.1 g of the Pigment Yellow 180 media milled dispersion were then added 21.8 g of Kao C binder, 0.25 g of Structure 1a (1.0), 0.75 g of Structure 2b (3.0%) and 26.2 g of ethyl acetate. This mixture was comprised of 10.0% pigment and 90.0% binder and comprised the organic phase in the evaporative limited coalescence process. The organic phase was then mixed with an aqueous phase comprising 85 ml of pH4 buffer containing 12.5 g of Nalco™ 1060 and 2.7 ml of 10% poly (adipic acid-comethylaminoethanol). This mixture was then subjected to very high shear using a Polytron sold by Brinkman followed by a Microfluidizer. Upon exiting, the solvent was removed from the particles so formed by stirring overnight at room temperature in an open container. These particles were washed with 0.1N potassium hydroxide solution to remove the silica followed by water and dried. The toner particles were of the order of 3.9μ volume average and entirely non-spherical with BET number of 1.19 m²/g.

### Example 6

The procedure of Example 5 was repeated with the exception that Structure 2b was replaced with 0.75 g of Structure 2c (3.0%). The resultant particles were completely non-spherical and particle size was 4.0% with BET number of 1.44 m²/g.

### Example 7

The procedure of Example 5 was repeated with the exception that Structure 2b was replaced with 0.75 g of Structure 2d (3.0%). The resultant particles were completely non-spherical and particle size was 3.8% with BET number of 1.35 m²/g.

### Example 8

To 37.0 g of the Hostaperm Pink media milled dispersion were then added 20.2 g of KAO C binder. 0.25 g of Structure 1a (1.0%), 0.25 g of Structure 3a (1.0%) and 26.2 g of ethyl acetate. This mixture was comprised of 17.5% pigment and 82.5% binder and comprised the organic phase in the evaporative limited coalescence process. The organic phase was then mixed with an aqueous phase comprising 85 ml of pH4 buffer containing 14.5 g of Nalco™ 1060 and 3.2 ml of 10% poly (adipic acid-comethylaminoethanol). This mixture was then subjected to very high shear using a Polytron sold by Brinkman followed by a Microfluidizer. Upon exiting, the solvent was removed from the particles so formed by stirring overnight at room temperature in an open container. These particles were washed with 0.1N potassium hydroxide solution to remove the silica followed by water and dried. The toner particles were of the order of 3.7μ volume average and entirely non-spherical with BET number of 2.31 m²/g.

### Example 9

The procedure of Example 8 was repeated with the exception that Structure 3a was replaced with 0.25 g of Structure 3b (1.0%). The resultant particles were completely non-spherical and particle size was 3.5μ with BET number of 2.24 m²/g.

### Example 10

The procedure of Example 8 was repeated with the exception that magenta pigment was replaced with 10.0% BrAIPc/CuPc cyan pigment. The resultant particles were completely non-spherical and particle size was 3.7μ with BET number of 1.34 m²/g.

### Example 11

The procedure of Example 9 was repeated with the exception that magenta pigment was replaced with 10.0% BrAIPc/CuPc cyan pigment. The resultant particles were completely non-spherical and particle size was 3.6μ with BET number of 2.21 m²/g.

### Example 12

The procedure of Example 8 was repeated with the exception that magenta pigment was replaced with 10.0% Pigment Yellow 180. The resultant particles were completely non-spherical and particle size was 4.0μ with BET number of 1.75 m²/g.

### Example 13

The procedure of Example 9 was repeated with the exception that magenta pigment was replaced with 10.0% Pigment Yellow 180. The resultant particles were completely non-spherical and particle size was 3.9μ with BET number of 1.55 m²/g.

### Example 14

The procedure of Example 8 was repeated with the exception that magenta pigment was replaced with 8.0% carbon black (Black Pearls 280). The resultant particles were completely non-spherical and particle size was 3.6μ with BET number of 1.08 m²/g.

The BET results (Single Point Monosorb™ BET by Quantachrome Corporation) tabulated in Table 1 support the present claim of controlling the toner morphology by the introduction of these materials. BET value of approximately 1.00 m²/g denotes sphericity in the toner as is illustrated in comparative I, II, III, and IV. BET values were calculated according to P. Chenebault and A. Schrenkamper, The Measurement Of Small Surface Areas By the B.E.T. Adsorption Method, The Journal of Physical Chemistry, Volume 69, Number 7, July 1965, pages 2300-2305.

TABLE 1

| EXAMPLES | BET VALUE (m²/g) _{—} |
|---|---|
| Comparative I | 0.90 |
| Comparative II | 0.60 |
| Comparative III | 0.95 |
| Comparative IV | 0.50 |
| Example 1 | 2.23 |
| Example 2 | 1.99 |
| Example 3 | 1.93 |
| Example 4 | 1.26 |
| Example 5 | 1.19 |
| Example 6 | 1.44 |
| Example 7 | 1.35 |
| Example 8 | 2.31 |
| Example 9 | 2.24 |
| Example 10 | 1.34 |
| Example 11 | 2.21 |
| Example 12 | 1.75 |
| Example 13 | 1.55 |
| Example 14 | 1.08 |

### Charge Control Properties

Charge control properties of the above tetraphenyl borate quaternary salts are tabulated on Table 2. The triboelectric charge of electrophotographic developers changes with life. This instability in charging level is one of the factors that require active process control systems in electrophotographic printers to maintain consistent print to print image density. It is desirable to have low charge/mass (Q/m) developers that are stable with life. The low Q/m has the advantage of improved electrostatic transfer and higher density capabilities.

It is desirable to lower the absolute Q/m of toners. The lower Q/m offers advantages of improved transfer and higher image densities. However, low Q/m is often achieved at a severe penalty in the throw-off (dust level) which is undesirable as it results in dusty developers. Low throw-off values (<20 mg/g of dust per g added fresh toner) combined with low Q/m is desirable.

TABLE 2

| | New | | | Strip & | | |
|---|---|---|---|---|---|---|
| | 10BB | Developer | TO | 10BB | Rebuild | 60BB |
| Reference # | Q/M | % TC | (mg/g) | Q/M | % TC | TO (mg/g) |
| Comparative | −74 | 6.0 | 2.5 | −93 | 6.0 | 2.6 |
| Example I | | | | | | |
| Comparative | −156 | 5.0 | 1.9 | −175 | 5.2 | 0.2 |
| Example II | | | | | | |
| Comparative | −151 | 5.3 | 2.8 | −178 | 5.4 | 1.0 |
| Example III | | | | | | |
| Comparative | −86 | 5.7 | 4.2 | −86 | 6.0 | 1.6 |
| Example IV | | | | | | |
| Example 1 | −101 | 5.4 | 6.2 | −102 | 5.7 | 3.1 |
| Example 2 | −108 | 5.2 | 13.9 | −116 | 5.6 | 14.6 |
| Example 3 | −54 | 6.0 | 3.9 | −69 | 6.0 | 2.3 |
| Example 4 | −121 | 5.7 | 3.1 | −131 | 5.7 | 1.0 |
| Example 5 | −101 | 5.5 | 0.2 | −104 | 6.1 | 0.1 |
| Example 6 | −47 | 5.7 | 2.1 | −52 | 6.1 | 0.0 |
| Example 7 | −79 | 5.7 | 2.7 | −83 | 6.0 | 1.8 |
| Example 8 | −65 | 5.5 | 3.0 | −73 | 5.9 | 0.7 |
| Example 9 | −62 | 5.4 | 15.1 | −60 | 5.9 | 2.3 |
| Example 10 | −97 | 5.5 | 8.9 | −78 | 5.8 | 6.9 |
| Example 11 | −65 | 5.7 | 56.7 | −53 | 5.5 | 28.9 |
| Example 12 | −75 | 5.8 | 3.9 | −78 | 6.0 | 3.1 |
| Example 13 | −76 | 5.6 | 9.8 | −77 | 6.0 | 1.0 |
| Example 14 | −151 | 5.2 | 1.4 | −135 | 5.9 | 1.0 |

TABLE 3
Copoly[4-vinylbenzylammonum tetraphenylborates]
Where Z =

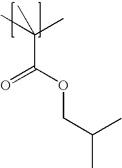

| Reference | | | | m | n | IV | |
|---|---|---|---|---|---|---|---|
| Structure | R¹ | R² | R³ | (wt %) | (wt %) | (DCM) | Tg, C |
| Structure | CH₃ | C₁₈H₃₇ | CH₃ | 10 | 90 | 0.66 | 59.5 |
| 2a | | | | | | | |
| Structure | CH₃ | CH₂C₆H₅ | CH₃ | 10 | 90 | 0.45 | 67.5 |
| 2b | | | | | | | |
| Structure | CH₃ | C₄H₉ | CH₃ | 10 | 90 | 0.55 | 66.6 |
| 2c | | | | | | | |
| Structure | CH₃ | C₈H₁₇ | CH₃ | 10 | 90 | 0.48 | 65.4 |
| 2d | | | | | | | |

TABLE 4
Quaternary Ammonium Tetraphenylborates

| Reference | | | | | | | | Calcd | | | | Found | | |
|---|---|---|---|---|---|---|---|---|---|---|---|---|---|---|
| Structure | R¹ | R² | R³ | R⁴ | Yield % | mp, C. | C | H | N | B | C | H | N | B |
| Structure 3a | CH₃ | CH₃ | C₁₈H₃₇ | CH₂C₆H₅ | 81.9 | 131.5–30 | 86.5 | 10 | 2 | 1.53 | 86.05 | 10.14 | 1.93 | 1.69 |
| Structure 3b | CH₃ | CH₃ | C₁₈H₃₇ | C₁₈H₃₇ | 62.1 | 81.5–3.5 | 85.6 | 11.6 | 1.6 | 1.24 | 85.31 | 12.07 | 1.6 | 1.39 |

TABLE 5
Quaternary Ammonium Tetraphenylborates

| Refer- | | | | | | | | | | Calcd | | | | Found | | |
|---|---|---|---|---|---|---|---|---|---|---|---|---|---|---|---|---|
| ence Structure | R1 | R2 | R3 | R4 | R5 | R6 | mp, C. | Yield % | C | H | N | B | C | H | N | B |
| Structure 1a | C₁₁H₂₃ | CH₂CH₂CH₂ | CH₃ | CH₂C₆H₅ | CH₃ | H | 113–15 | 33.0 | 83.00 | 9.10 | 4.00 | 1.60 | 82.85 | 9.22 | 3.98 | 1.60 |
| Structure 1b | C₁₁H₂₃ | CH₂CH₂CH₂ | CH₃ | CH₃ | CH₃ | H | 173.5 | 82.1 | 81.50 | 9.60 | 4.50 | 1.75 | 81.35 | 9.73 | 4.52 | 1.88 |
| Structure 1c | C₅H₁₁ | CH₂CH₂CH₂ | CH₃ | CH₂C₆H₅ | CH₃ | H | 148–50 | 82.60 | 82.60 | 8.40 | 4.60 | 1.77 | 85.42 | 8.45 | 4.60 | 1.91 |
| Structure 1d | C₁₁H₂₃ | CH₂CH₂ | CH₃ | CH₂C₆H₅ | CH₃ | H | 125.6 | 82.90 | 82.90 | 9.00 | 4.10 | 1.59 | 82.86 | 9.23 | 4.16 | 1.72 |

The invention has been described in detail with particular reference to certain preferred embodiments thereof, but it will be understood that variations and modifications can be effected within the spirit and scope of the invention.

1. A method for the preparation of electrostatographic toner comprising the steps of:
a) dissolving a polymer material and a quaternary ammonium tetraphenylborate salt in an organic solvent to form an organic phase;
b) dispersing the organic phase in an aqueous phase comprising a particulate stabilizer to form a dispersion and homogenizing the resultant dispersion;
c) evaporating the organic solvent and recovering a resultant product; and
d) washing and drying the resultant product.

2. The method of claim 1 wherein the quaternary ammonium tetraphenylborate salt is selected from the group consisting of 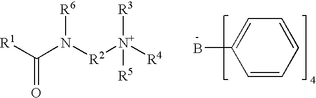
where R¹ is substituted or unsubstituted alkyl or aryl; R² is alkylene or arylene; R³, R⁴ and R⁵ are substituted or unsubstituted alkyl and R³ and R⁴ taken together may form a cyclic ring system and R⁶ is hydrogen or alkyl, 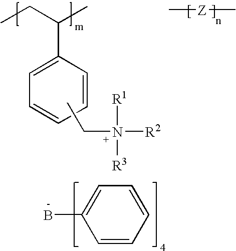
where R¹, R² and R³ are the same or different and are alkyl or substituted alkyl and taken together may form a cyclic ring structure, Z is any copolymerizable monomer residue and may include more than one comonomer or 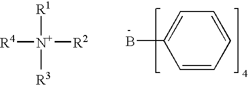
where R¹, R², R³ and R⁴ are the same or different and are alkyl or substituted alkyl, R¹ and R² taken together may form a cyclic ring system.

3. The method of claim 1 wherein a charge control agent is added in step a).

4. The method of claim 1 wherein a pigment is added in step a).

5. The method of claim 4 wherein the pigment comprises from 4 to 20 weight percent of the resultant product.

6. The method of claim 1 wherein a promoter is added in the dispersing step in b).

7. The method of claim 1 wherein the solvent is selected from the group consisting of chloroform, dichloromethane, ethyl acetate, vinyl chloride, and methyl ethyl ketone.

8. The method of claim 1 wherein the amount of particulate stabilizer is between 1 to 15 parts, by weight, based on 100 parts of total solids in the toner.

9. The method of claim 1 wherein the ratio of the aqueous phase to the organic phase, by volume, ranges from 1:1 to 9:1.

10. The method of claim 1 wherein the organic phase contains lubricants.

11. The method of claim 1 wherein the organic phase contains waxes.

12. The method of claim 1 wherein the polymer material is a homopolymer or copolymer.

13. The method of claim 12 wherein the homopolymer or copolymer is selected from the group consisting of polyethylene, polypropylene, polyisobutylene, polyisopentylene, polytrifluoroolefins, polyamides, acrylic resins, ethylene-methyl acrylate copolymers, ethylene-ethyl acrylate copolymers, ethylene-ethyl methacrylate copolymers, polystyrene and copolymers of styrene with unsaturated monomers, polyesters, polyvinyl resins, ethylene-allyl alcohol copolymers, polytetrafluoroethylene, polytrifluorochloroethylene, poly(hexamethylene adipamide), poly(hexamethylene sebacamide), polycaprolactam, poly(methyl methacrylate), poly(methyl acrylate), poly(ethyl methacrylate) and poly(styrene-methyl methacrylate).

14. The method of claim 1 wherein the polymer material is polyester.

15. The method of claim 1 wherein the polymer material is butyl acrylate-styrene copolymer.
